(19) United States
(12) Patent Application Publication
(10) Pub. No.: US 2023/0161150 A1
(43) Pub. Date: May 25, 2023

(54) MICROMIRROR ARRANGEMENT

(71) Applicant: Robert Bosch GmbH, Stuttgart (DE)

(72) Inventor: Johannes Classen, Reutlingen (DE)

(21) Appl. No.: 17/917,343

(22) PCT Filed: Jul. 16, 2021
(86) PCT No.: PCT/EP2021/069996

§ 371 Date: Oct. 6, 2022

(30) Foreign Application Priority Data
Sep. 4, 2020 (DE) 10 2020 211 173.1

(51) Int. Cl. G02B 26/08; G02B 17/00

(52) U.S. Cl. CPC G02B 26/0841; G02B 17/002

(57) ABSTRACT

A micromirror arrangement having at least a first micromirror, a second micromirror, and a third micromirror. The second micromirror has a first component and a second component. The first component is arranged, in particular in a plan view, in a manner overlapping a first mirror surface of the first micromirror. The second component is arranged, in particular in the plan view, in a manner overlapping a third mirror surface of the third micromirror.

### FIELD

The present invention relates to a micromirror arrangement. The present invention also relates to a projection apparatus comprising the micromirror arrangement.

### BACKGROUND INFORMATION

U.S. Patent Application Publication No. US 2005/0157376 A1 describes a micromirror arrangement in which spring elements of a mirror project into the area of an adjacent mirror.

An object of the present invention is to develop a micromirror arrangement having increased driving force and/or increased deflectability of the micromirrors.

### SUMMARY

According to the present invention, to achieve the object, a micromirror arrangement and a projection apparatus are provided.

According to an example embodiment of the present invention, the micromirror arrangement comprises at least a first micromirror, a second micromirror, and a third micromirror. The second micromirror comprises a first and a second component. The first and the second component are in particular functional components of the respective micromirror. A functional component is a component of the respective micromirror that is technically significant for any function of the respective micromirror. An electrostatic comb drive element as a functional component, for example, is configured for driving the respective micromirror. A micromechanical spring element as a functional component is configured for deflecting the respective micromirror. A capacitive electrode arrangement as a functional component is configured for detecting the deflection of the respective micromirror. The first component is disposed such that it overlaps the first micromirror. The first component is in particular disposed such that, in plan view, it overlaps a first mirror surface of the first micromirror. The first component in particular extends underneath the first mirror surface in plan view. The second component is furthermore disposed such that it overlaps the third micromirror. The second component is in particular disposed such that, in plan view, it overlaps a third mirror surface of the third micromirror. The second component in particular extends underneath the third mirror surface in plan view. The available space for the components of the second micromirror can thus be increased, as a result of which the lever arm and/or the torques for deflecting the second micromirror, for example, can be increased as well.

According to an example embodiment of the present invention, the at least first, second and third micromirrors are preferably arranged as an array, in particular a micromirror array. The first, second and third micromirrors are hereby in particular disposed side by side, laterally spaced apart from one another. In particular in plan view, the second micromirror is preferably disposed between the first and the third micromirror. Such an array arrangement can have a one-dimensional or two-dimensional configuration and can be used, for example, in image projectors for deflecting light beams. Other important applications include so-called reconfigurable optical add-drop multiplexers (ROADM), in which signals of specific wavelengths or frequencies can be coupled selectively into glass fibers in glass fiber networks via a micromirror array. Micromirror arrays can furthermore also be used in modern projection exposure systems for microlithography in the semiconductor industry.

According to an example embodiment of the present invention, the first micromirror preferably additionally comprises at least one third component. This third component is likewise in particular configured as a third functional component. The third component is disposed such that it overlaps the second micromirror. The third component is in particular disposed such that, in plan view, it overlaps a second mirror surface of the second micromirror. The components of the first and second micromirror therefore mutually overlap one another. A first main extension plane, in particular in plan view, of the first component, and a third main extension plane, in particular in plan view, of the third component further preferably extend substantially parallel to one another. The first main extension plane and the third main extension plane in particular extend side by side parallel. There is therefore no overlapping of the first and the third component in plan view. The first and the third component preferably have cross-sections that differ from one another. The cross-section of the third component, in particular in plan view, is in particular narrower than the cross-section of the first component. The components are therefore configured differently from one another. Alternatively, the first and the third component have cross-sections that are the same. The cross-section of the third component, in particular in plan view, is in particular the same as the cross-section of the first component. The components are therefore configured identically. The first micromirror is hereby further preferably configured identically to the second micromirror. The third micromirror is preferably likewise configured identically to the first and the second micromirror.

According to an example embodiment of the present invention, the first, second, and third micromirrors are preferably disposed along a common first main extension plane of the micromirrors. The first, second and third micromirrors, in particular a first main extension plane of the first micromirror, a second main extension plane of the second micromirror and a third main extension plane of the third micromirror, hereby preferably extend on the common first main extension plane and thus form a rectilinear, one-dimensional array. Alternatively, the first, second and third micromirrors, in particular the first main extension plane of the first micromirror, the second main extension plane of the second micromirror and the third main extension plane of the third micromirror, are preferably disposed along the common main extension plane, offset from the main extension plane. The main extension planes of the individual micromirrors therefore do not extend on the common main extension plane, but rather offset from said main extension plane. The micromirrors are thus likewise disposed offset from one another along the one-dimensional array. This consequently makes it possible to one-dimensionally arrange identical micromirrors as an array.

According to an example embodiment of the present invention, the first, second, and third micromirrors are preferably arranged as at least a part of a two-dimensional array. The first and the second micromirror extend in the y-direction, for example, and the second and the third micromirror extend in the x-direction of the two-dimensional array.

According to an example embodiment of the present invention, the at least first, second and third micromirrors preferably have a common carrier substrate. The carrier substrate is preferably made of silicon.

According to an example embodiment of the present invention, the components of the micromirrors are preferably made at least in part of silicon.

According to an example embodiment of the present invention, the components of the micromirrors preferably represent at least parts of micromechanical spring elements. The first component of the second micromirror is in particular configured as a first subsection of a first micromechanical spring, in particular a first torsion spring, and the second component of the second micromirror is configured as a second subsection of the first micromechanical spring as the second component. The two subsections are in particular configured as partial turns to the right and left of a vertical axis, in particular a vertical mount of the first micromechanical spring. Overlapping the respective subsection with the adjacent micromirror increases the installation space for the micromechanical spring. This reduces the achievable spring stiffness of the micromechanical spring and consequently increases the possible deflectability of the respective micromirror.

According to an example embodiment of the present invention, the components of the micromirrors preferably represent at least parts of a comb drive, in particular a vertical comb drive, of a respective micromirror. One component is in particular configured as a movable comb and a connecting web of the movable comb with the underside of the mirror. The vertical comb drive consists of fixed combs and movable combs connected to the underside of the mirror. When an electrical voltage is applied to either the comb drive disposed to the left or the comb drive disposed to the right of a mount, the mirror is tilted about a specific axis of rotation. Overlapping the comb drive with an adjacent micromirror increases the installation space, in particular the achievable lever arm, for the comb drive, and thus increases a possible torque of the respective micromirror.

According to an example embodiment of the present invention, the micromirror arrangement preferably comprises at least four micromirrors, in particular at least sixteen micromirrors, arranged in a two-dimensional, in particular 4×4, array.

According to an example embodiment of the present invention, the micromirror arrangement preferably has a fill factor of at least 60%. The fill factor is hereby preferably at least 80%, particularly preferably at least 90%, for a one-dimensional array and at least 60%, particularly preferably at least 80%, for a two-dimensional array. Fill factor refers to the ratio of the area of mirror surface to the total surface area of the array. Because the functional elements overlap the respective adjacent mirrors, whereby the functional elements of the respective adjacent mirrors are not in mutual contact with one another, the micromirrors can be pushed into one another as it were, so that the mirror surfaces of the adjacent micromirrors can be close to one another.

A further subject matter of the present invention is a projection apparatus comprising at least one of the above-described micromirror arrangement. Such a projection apparatus preferably further comprises an illumination unit and a projection unit, in particular a screen.

### BRIEF DESCRIPTION OF THE DRAWINGS

FIG. 1A schematically shows a first embodiment of a micromirror arrangement in plan view, according to the present invention.

FIG. 1B schematically shows a sectional view of the first embodiment of the micromirror arrangement, according to the present invention.

FIG. 2 schematically shows a second embodiment of the micromirror arrangement in plan view, according to the present invention.

FIG. 3 schematically shows a third embodiment of the micromirror arrangement in plan view, according to the present invention.

FIG. 4 schematically shows a fourth embodiment of the micromirror arrangement in plan view, according to the present invention.

FIG. 5 schematically shows a fifth embodiment of the micromirror arrangement in plan view, according to the present invention.

FIG. 6 schematically shows a sixth embodiment of the micromirror arrangement in plan view, according to the present invention.

FIG. 7A schematically shows a seventh embodiment of the micromirror arrangement in plan view, according to the present invention.

FIG. 7B schematically shows a sectional view of the seventh embodiment of the micromirror arrangement, according to the present invention.

FIG. 8 schematically shows a projection apparatus, according to the present invention.

### DETAILED DESCRIPTION OF EXAMPLE EMBODIMENTS

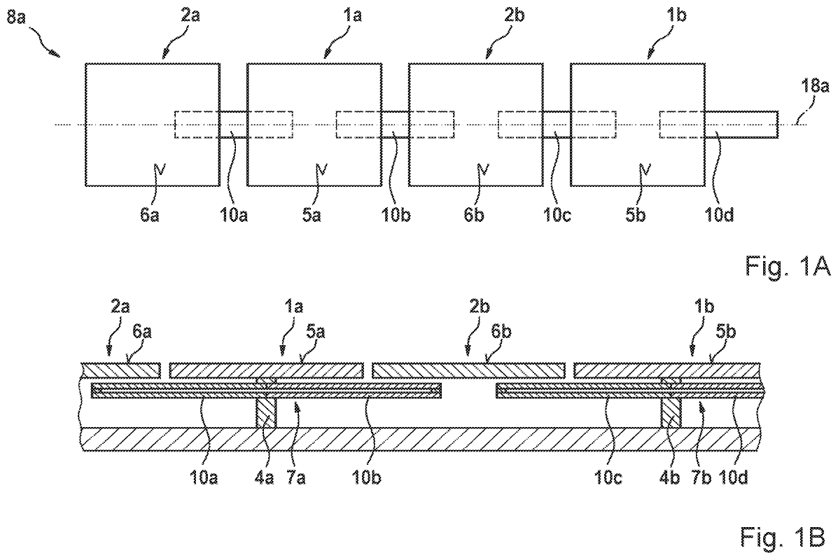

FIG. 1A schematically shows a first embodiment of a micromirror arrangement 8a in plan view. The micromirror arrangement 8a comprises a first micromirror 2a, a second micromirror 1a, a third micromirror 2b and a fourth micromirror 1b. The second micromirror 2a comprises a first component 10a, in particular a first functional component, and a second component 10b, in particular a second functional component. The first component 10a is disposed such that, in plan view, it overlaps a first mirror surface 6a of the first micromirror 2a. The second component 10b is furthermore disposed such that, in plan view, it overlaps a third mirror surface 6b of the third micromirror 2b. The second micromirror 1a is disposed between the first 2a and the third micromirror 2b. The first 10a and the second component 10b are configured identically to one another and therefore have cross-sections that are the same in plan view.

In this first embodiment, the first 2a and the third micromirror 2b are configured identically to one another. The fourth micromirror 1b in this first embodiment is likewise configured identically to the second micromirror 1a and comprises a seventh component 10c, in particular a seventh functional component, and an eighth component 10d, in particular an eighth functional component. All components 10a-10d in this first embodiment are therefore configured identically to one another. The seventh component 10c is furthermore disposed such that, in plan view, it overlaps a third mirror surface 6b of the third micromirror 2b. In this first embodiment, the four micromirrors 1a, 1b, 2a and 2b have a common main extension plane 18a, on which all of the micromirrors 1a, 1b, 2a and 2b extend.

The first 2a, the second 1a, the third 2b and the fourth micromirror 1b are arranged as a one-dimensional, in particular rectilinear, array.

FIG. 1B schematically shows a sectional view of the first embodiment of the micromirror arrangement 8a along the common main extension plane 18a. As can be seen there, the first component 10a represents a first part, in particular a first subpart, and the second component 10b represents a second part, in particular a second subpart, of a first micromechanical spring element 7a, which is disposed on a common carrier substrate 16a of the micromirror arrangement 8a by means of a first mount 4a. The first 10a and the second component 10b extend underneath the first mirror surface 6a and underneath the third mirror surface 6b. A partial section of the fourth micromirror 1b with the seventh 10c and the eighth component 10d can similarly be seen here as well. The seventh component 10c represents a third part, in particular a third subpart, and the eighth component 10d represents a fourth part, in particular a fourth subpart, of a second micromechanical spring element 7b, which is disposed on the common carrier substrate 16a of the micromirror arrangement 8a by means of a second mount 4b.

The micromechanical spring elements 7a and 7b are made entirely of silicon. The mounts 4a and 4b and also the carrier substrate 16a are likewise made of silicon.

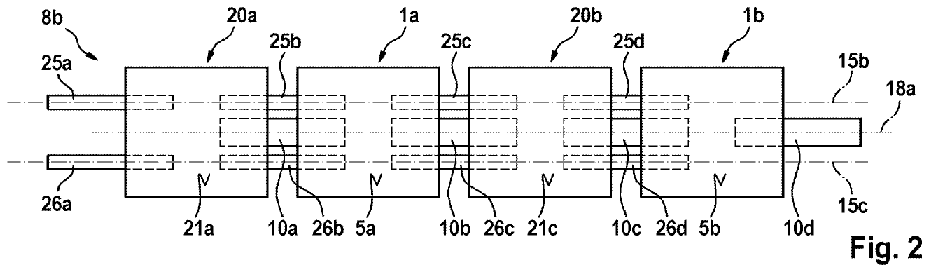

FIG. 2 schematically shows a second embodiment of a micromirror arrangement 8b. In contrast to the first embodiment, the first micromirror 20a additionally comprises at least a third component 26b, in particular a third functional component. The third component 26b is disposed such that, in plan view, it overlaps the second mirror surface 5a of the second micromirror 1a. A first main extension plane 15a of the first component 10a and a third main extension plane 15c of the third component 26b extend substantially parallel to one another. The first 10a and the third component 26b are disposed adjacent one another.

The first 10a and the third component 26b have cross-sections that differ from one another in plan view and are therefore configured differently from one another. The third component 26b has a cross-section that is narrower than the cross-section of the first component 10a.

The first micromirror 20a in this embodiment additionally comprises a further fourth component 25b, in particular a functional component. The fourth component 25b is configured identically to the third component 26b. A fourth main extension plane 15b of the fourth component 25b, the third main extension plane 15c of the third component 26b and the first main extension plane 15a of the first component 10a extend substantially parallel to one another. In plan view, the first component 10a is disposed between the third 26b and the fourth component 25b.

The first micromirror 20a further comprises a fifth component 25a, which is disposed on the fourth main extension plane 15b and is configured identically to the fourth component 25b. The fifth component is disposed on the opposite side of the first micromirror 20a with respect to the fourth component 25b. The first micromirror 20a further comprises a sixth component 26, which is disposed on the third main extension plane 15c and is configured identically to the third component 26b. The sixth component is disposed on the opposite side of the first micromirror 20a with respect to the third component 26b.

The third micromirror 20b is configured identically to the first micromirror 20a and comprises a ninth 26c, a tenth 25c, an eleventh 26d and a twelfth component 25d which overlap the adjacent mirror surfaces 5a and 5b.

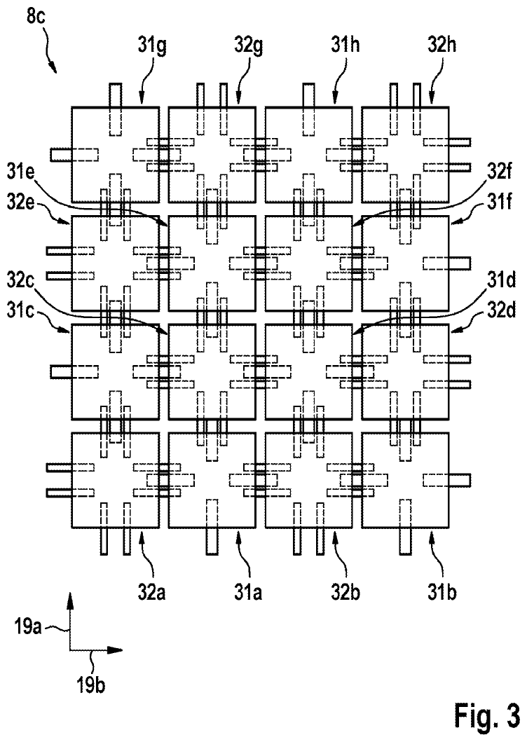

FIG. 3 shows a third micromirror arrangement 8c, wherein, in contrast to the previous embodiments, the micromirrors 31a-31h and 32a-32h are arranged as a two-dimensional 4×4 array, which extends rectilinearly in the x-direction 19b and the y-direction 19a. The micromirrors 31a-31h are configured identically to the second micromirror 1a and the fourth micromirror 1b from the previous embodiments, with the difference that the micromirrors 31a-31h comprise a respective component on each side of the mirror surface, which is rectangular in shape here, that overlaps the respective adjacent mirrors 32a-32h. The micromirrors 32a-32h are configured identically to the first micromirror 20a and the third micromirror 20b from the previous second embodiment, with the difference that the micromirrors 31a-31h comprise two respective components on each side of the mirror surface, which is rectangular in shape here, that overlap the respective adjacent mirrors 31a-31h.

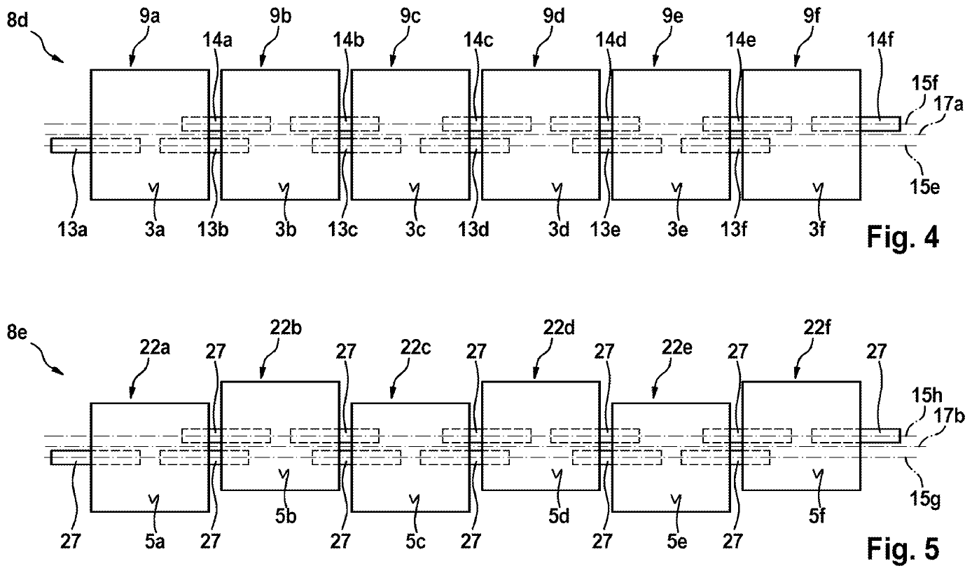

FIG. 4 schematically shows a fourth embodiment of a micromirror arrangement 8d. In contrast to the first embodiment of FIGS. 1A and 1B, a second micromirror 9b and a first micromirror 9a comprise a first component 14a, a second component 14b and a third component 13b, the cross-sections of which are identical to one another in plan view. Here, too, a first main extension plane 15f in plan view of the first component 14a and a third main extension plane 15e of the third component 15e extend substantially parallel to one another. The micromirrors 9a-9f are configured identically to one another, but are alternately rotated 180° in the micromirror arrangement 8d. This prevents the components of adjacent micromirrors overlapping one another. The micromirrors 9a-9f extend on the common main extension plane 17a.

FIG. 5 schematically shows a fifth embodiment of a micromirror arrangement 8e. In contrast to the fourth embodiment, the micromirrors 22a-22f, which are configured identically to one another, are disposed along the common main extension plane 17b offset from the common main extension plane 17b. To achieve this, the micromirrors 22a-22f are alternately disposed above and beneath the common main extension plane 17b in plan view.

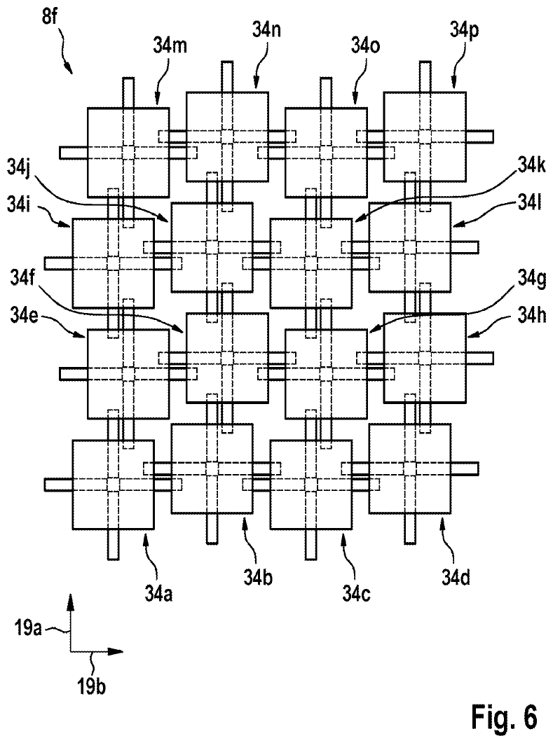

FIG. 6 shows a sixth micromirror arrangement 8f, wherein, in contrast to the fifth embodiment, the identical micromirrors 34a-34p are arranged as a two-dimensional 4×4 array, which extends in the x-direction 19b and the y-direction 19a. The micromirrors 34a-34p are configured and disposed relative to one another identically to the micromirrors 22a-22f of the fifth embodiment, with the difference that the micromirrors 34a-34p comprise a respective component on each side of the mirror surface, which is rectangular in shape here, that overlaps the respective adjacent mirrors.

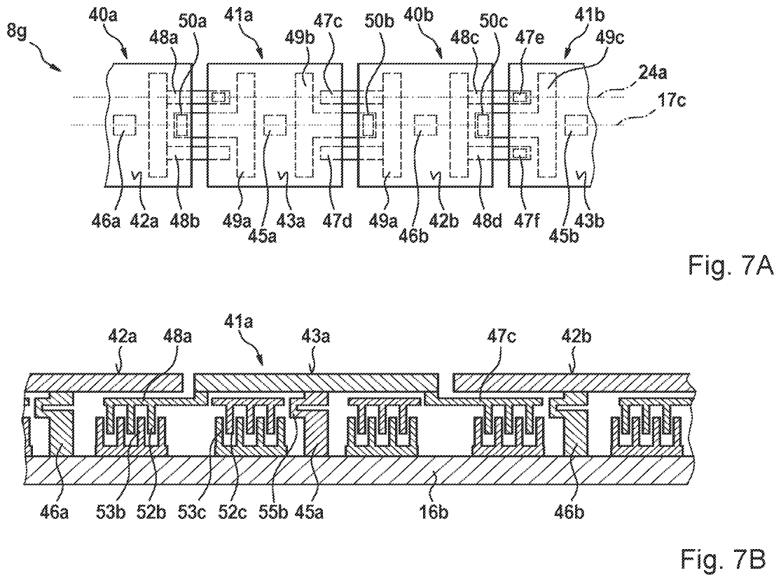

FIG. 7A schematically shows a seventh embodiment of a micromirror arrangement 8g. In contrast to the previous embodiments, the second micromirror 41a comprises a first component 48a and a second component 47c which, as functional components, represent parts of a vertical comb drive and overlap the first mirror surface 42a and the third mirror surface 42b of the adjacent first micromirror 40a and third micromirror 40b.

The second micromirror 41a further comprises a fourth component 48b and a fifth component 47d that likewise overlap the first mirror surface 42a and the third mirror surface 42b of the adjacent first micromirror 40a and third micromirror 40b. The first micromirror 40a in turn comprises a third component 50a, which is also configured as a part of a vertical comb drive and overlaps the second mirror surface 43a of the second micromirror 41a. The third micromirror 40b is configured identically to the first micromirror 40a and the fourth micromirror 41b, which is indicated here only in part, is configured identically to the second micromirror 41a.

FIG. 7B schematically shows a portion of a sectional view of the seventh embodiment of the micromirror arrangement 8g along the sectional plane 24a. As shown there using the second micromirror 41a, the first component 48a is configured as a movable comb of a vertical comb drive, which is connected to the underside of the mirror of the second mirror surface 43a via a connecting web. The comb surfaces 52b of the movable comb are in engagement with the comb surfaces of a fixed comb 53b attached to the carrier substrate 16b. The first component 48a extends underneath the first mirror surface 42a and is disposed such that it overlaps said first mirror surface, in particular in plan view. Similarly, the second component 47c is configured as a movable comb on the opposite side of the second micromirror 41a and is disposed such that it overlaps the third mirror surface 42b. When an electrical voltage is applied to either the comb drive 48a disposed to the left or the comb drive 47c disposed to the right of a second mount 45a, the second micromirror 41a is tilted about an axis of rotation that projects into the image plane. The first micromirror is attached to the carrier substrate 16b via a first mount 46a and the third micromirror via a third mount 46b.

As can be seen from FIGS. 1A-7B, the mirror surfaces of the adjacent micromirrors can be disposed very close to one another, even though the extent of at least the second micromirror along the main extension plane is greater than the lateral spacing between the midpoints of the mirror surfaces of adjacent mirrors. This makes it possible to realize micromirror arrangements having a particularly high fill factor. For a one-dimensional array, the fill factor is preferably at least 80%, particularly preferably at least 90%, and for a two-dimensional array at least 60%, particularly preferably at least 80%.

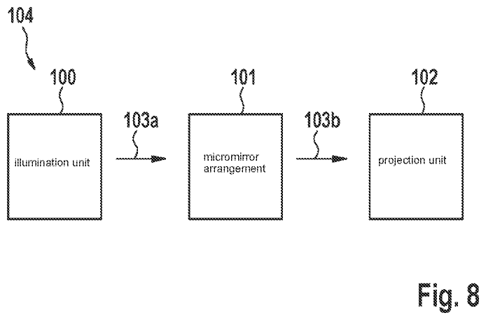

FIG. 8 schematically shows a projection apparatus 104 comprising a micromirror arrangement 101 according to any one of the previous embodiments. The projection apparatus 104 further comprises an illumination unit 100 and a projection unit 102, which is in particular configured as a screen. The illumination unit 100, which is configured as a laser diode, for example, produces at least one light beam 103a which is deflected by the micromirror arrangement 101, in particular in a scanning manner. The at least one deflected light beam 103b is thus projected onto the projection unit 102.

1-16. (canceled)

17. A micromirror arrangement, comprising:
at least a first micromirror, a second micromirror, and a third micromirror;
wherein the second micromirror includes a first component and a second component, the first and second components being first and second functional components, the first component being disposed such that, in plan view, the first component overlaps a first mirror surface of the first micromirror, and the second component is disposed such that, in plan view, the second component overlaps a third mirror surface of the third micromirror.

18. The micromirror arrangement according to claim 17, wherein the at least first, second, and third micromirror are arranged as an array.

19. The micromirror arrangement according to claim 18, wherein the second micromirror is disposed between the first and the third micromirror.

20. The micromirror arrangement according to claim 17, wherein the first micromirror further includes at least one third component, the third component being a third functional component, wherein the third component is disposed such that, in plan view, the third component overlaps a second mirror surface of the second micromirror.

21. The micromirror arrangement according to claim 20, wherein a first main extension plane, in plan view, of the first component, and a third main extension plane, in plan view, of the third component extend substantially parallel to one another, side by side.

22. The micromirror arrangement according to claim 20, wherein the first and the third component have cross-sections that differ from one another.

23. The micromirror arrangement according to claim 20, wherein the first and the third component have cross-sections that are the same.

24. The micromirror arrangement according to claim 17, wherein the first, second, and third micromirror are disposed along a common first main extension plane.

25. The micromirror arrangement according to claim 24, wherein the first, second, and third micromirror are disposed along the common main extension plane offset from a main extension plane.

26. The micromirror arrangement according to claim 17, wherein the at least first, second, and third micromirror have a common carrier substrate.

27. The micromirror arrangement according to claim 17, wherein components of the first, second, and third micromirrors are made at least in part of silicon.

28. The micromirror arrangement according to claim 17, wherein components of the micromirrors are at least parts of micromechanical spring elements.

29. The micromirror arrangement according to claim 17, wherein components of the micromirrors are at least parts of a vertical comb drive.

30. The micromirror arrangement according to claim 17, wherein the micromirror arrangement comprises at least sixteen micromirrors arranged in a 4×4, array.

31. The micromirror arrangement according to claim 17, wherein the micromirror arrangement has a fill factor of at least 90% for a one-dimensional array.

32. The micromirror arrangement according to claim 17, wherein the micromirror arrangement has a fill factor of at least 80% for a two-dimensional array.

33. A projection apparatus, comprising:
a micromirror arrangement including:
at least a first micromirror, a second micromirror, and a third micromirror,
wherein the second micromirror includes a first component and a second component, the first and second components being first and second functional components, the first component being disposed such that, in plan view, the first component overlaps a first mirror surface of the first micromirror, and the second component is disposed such that, in plan view, the second component overlaps a third mirror surface of the third micromirror.
